(19) United States
(12) Patent Application Publication
(10) Pub. No.: US 2024/0035555 A1
(43) Pub. Date: Feb. 1, 2024

(54) DRIVE WHEEL

(71) Applicant: Schaeffler Technologies AG & Co. KG, Herzogenaurach (DE)

(72) Inventors: Andreas Stuffer, Weingarten (DE); Yile Wu, Ingolstadt (DE); Fritz Kornmeier, Baden-Baden (DE)

(73) Assignee: Schaeffler Technologies AG & Co. KG, Herzogenaurach (DE)

(21) Appl. No.: 18/038,750

(22) PCT Filed: Oct. 18, 2021
(86) PCT No.: PCT/DE2021/100839

§ 371 Date: May 25, 2023

(30) Foreign Application Priority Data
Nov. 30, 2020 (DE) 10 2020 131 624.0
Mar. 1, 2021 (DE) 10 2021 104 889.3

(51) Int. Cl. F16H 55/36

(52) U.S. Cl. CPC F16H 55/36; F16H 2055/366

(57) ABSTRACT

A drive wheel, comprising a drive disk, which has a traction-means connection region; and a shaft connection region, which can be rotated relative to the traction-means connection region against damping action of a torsional vibration damping device having a spring accommodation chamber. The spring accommodation chamber is filled with lubrication medium and is closed via a cover. The cover has a groove facing the drive disk and containing a sealing means.

### CROSS-REFERENCE TO RELATED APPLICATIONS

This application is the U.S. National Phase of PCT Appln. No. PCT/DE2021/100839 filed Oct. 18, 2021, which claims priority to DE 102021104889.3 filed Mar. 1, 2020, which in turn claims priority to DE 102020131624.0 filed Nov. 30, 2020, the entire disclosures of which are incorporated by reference herein.

### TECHNICAL FIELD

The present disclosure relates to a drive wheel which has a drive disk comprising a traction-means connection region and a shaft connection region that can be rotated relative to the traction-means connection region against the damping action of at least one torsional vibration damping device, and a method for producing such a drive wheel.

### BACKGROUND

European patent specification EP 1 612 386 B1 describes a drive wheel for driving an auxiliary assembly of an internal combustion engine of a vehicle having a damping device, wherein the drive wheel can be coupled to a shaft and the damping device comprises at least one torsional vibration damper which operates without grease or oil lubrication and has a damper cage for receiving at least one spring accumulator designed as a compressible spring. International publication WO2008/058499 A2 describes a drive wheel having at least one drive disk and having a torsional vibration damping device that includes bow springs that are arranged in a grease-filled spring chamber that is sealed with the aid of sealing lips that are formed on a plastic part.

When using a belt pulley decoupler with such a drive disk, a cylindrical interference fit is used to close off the internal space between the drive disk and a cover. Depending on the tightness requirement, the viscosity of the internal medium and the macro and micro geometry of the components, the operating speed and/or the ambient temperature, an additional medium/sealing means is required to ensure tightness.

Nevertheless, in the case of the solutions with conventional component dimensions and tolerances, the desired tightness cannot be guaranteed under all circumstances without sealing means. Even with solutions with sealing means on the surfaces, there is no guarantee that this sealing means will be distributed evenly over the circumference since it is only “taken along” by the inserted cover into the interference fit during the pushing-in process or pressing-in process. Likewise, there is no guarantee that the interior space after assembly, i.e., the spring accommodation chamber, will not be contaminated by residues that are pushed along on the front edge of the cover.

### SUMMARY

The present disclosure provides, according to an exemplary embodiment, a drive wheel, which is of simple construction and/or can be produced inexpensively and offers good tightness. Furthermore, present disclosure provides a method for producing such a drive wheel.

The drive wheel according to the present disclosure serves to decouple vibrations and can therefore also be referred to as a drive wheel decoupler or belt pulley decoupler. Springs, in particular bow springs, may be used to decouple the vibrations.

The solution to the problem consists, inter alia, in that the inner body of the cylindrical interference fit consisting of the drive disk and cover of a drive wheel is provided with a groove into which a sealing means can be metered before assembly. The groove may be arranged over the entire circumference. The opening of the groove faces the radially inner surface of the drive disk. At the end of the assembly process, the drive wheel is subjected to the influence of speed, which means that the sealing means is automatically distributed over the region to be sealed and ensures a secure seal in a defined region.

The drive wheel according to the present disclosure having a drive disk, which has a traction-means connection region, and a shaft connection region which can be rotated relative to the traction-means connection region against the damping action of at least one torsional vibration damping device, wherein a spring accommodation chamber filled with lubricant is closed by means of a cover, is distinguished in that the cover has a groove facing the drive disk, which cover contains a sealing means.

A traction means, for example a belt, can be coupled to the drive wheel via the traction-means connection region and used to transmit torque. The relative rotation of the traction-means connection region and the shaft connection region takes place about a common axis of rotation. The designations “axial” and “radial” used in this document always refer to this axis of rotation. The sealing means is contained in the groove and, in particular after assembly, rests radially on the outside in the groove and thus may be on the drive disk and optionally on the cover. Before the drive wheel is installed, the sealing means is introduced into the groove and may be located at the base of the groove. As a result, contamination of the sealing means or discharge of the sealing means into regions in which it would represent a contamination can be reliably avoided. At the same time, when the drive wheel is subjected to a rotational speed, the sealing means is pushed radially outwards and seals against the drive disk radially on the inside. In this way, a sealing means application that is uniform in the circumferential direction can be achieved.

According to an exemplary embodiment, the cover is press-fitted into the drive disk, so that an interference fit is formed between the cover and the drive disk. In particular, the formation of a cylindrical transverse interference fit allows the assembly and formation of a non-positive connection between the cover and the traction disk in a simple manner.

According to an exemplary embodiment, the cover is mounted on a support body in the radial direction. This enables a simple construction of the drive wheel.

According to an exemplary embodiment, the cover is manufactured from sheet metal without machining, solely by means of forming. In this way, a simple production of the cover can be achieved. In particular, the groove can be produced without further processing steps. According to an exemplary embodiment, the cover remains unhardened after forming.

According to an exemplary embodiment, the sealing means is positioned radially on the outside in the groove. This is the case in particular after assembly, after the drive wheel with the introduced sealing means is set in rotation. Due to the applied centrifugal forces, the sealing means is pushed radially outwards and thus rests evenly on the drive wheel radially inwards.

According to an exemplary embodiment, an anaerobically hardened, in particular thixotropic sealing means is used as the sealing means. In this context, the use of a sealing means with a viscosity of 5,000 to 25,000 millipascal seconds, in particular 5,000 to 12,000 millipascal seconds, is preferred.

According to an exemplary embodiment, the drive disk and cover form an interference fit with a first contact region and a second contact region that are spaced apart from one another in the axial direction, wherein the groove is formed in the axial direction between the first contact region and the second contact region. Thus, the sealing means is also formed in the axial direction between the first contact region and the second contact region, so that displacement of the sealing means by rotation radially outward leads to both contact regions, which at the same time form the joints of the interference fit, being reliably sealed. In this way, the spring chamber of the drive wheel can be reliably sealed.

In this context, the sealing means may rest radially on the inside between the first contact region and the second contact region on the drive disk. The displacement of the sealing means by rotation thus may lead to the sealing means being displaced from a position radially on the outside of the cover, i.e., in the bottom of the groove, radially to the outside and resting there radially on the inside of the drive disk.

Furthermore, a method for manufacturing a drive wheel according to the present disclosure is proposed, having the following steps:
providing the drive disk with the torsional vibration damping device;
providing the cover;
introducing the sealing means into the groove;
press-fitting the cover into the drive disk;
applying a rotational movement to the combination of drive disk and cover, so that the sealing means is forced radially outwards out of the groove by means of centrifugal force and seals the joint between the drive disk and cover in an axial region.

The introduction of the sealing means into the groove of the cover prior to the formation of the interference fit means that the sealing means can be metered well, which effectively prevents the sealing means from being distributed outside of the joints. Due to the rotational movement, the sealing means is displaced radially outwards and thus the formation of a seal between the joints of the sealing assembly is reliably achieved and possible irregularities in the metering of the sealing means over the circumference are compensated for under the influence of centrifugal force. The details and advantages disclosed for the drive wheel can be transferred and applied to the manufacturing process and vice versa.

As a precaution, it should be noted that the numerical designations used here (“first”, “second”, etc.) serve primarily (only) to distinguish between several similar objects, sizes, or processes, and in particular no necessary dependency and/or sequence of these objects, sizes, or processes to each other is indicated. If a dependency and/or sequence is necessary, this is explicitly stated here or results in a manner obvious to the person skilled in the art when studying the specifically described configuration.

### BRIEF DESCRIPTION OF THE DRAWINGS

Both the present disclosure and the technical field are explained in more detail below with reference to the figures. It should be noted that the present disclosure is not intended to be limited by the exemplary embodiments shown. In particular, unless explicitly stated otherwise, it is also possible to extract partial aspects of the subject matter outlined in the figures and to combine them with other components and knowledge from the present description and/or figures. In particular, it should be noted that the figures and in particular the size ratios shown are only schematic in nature. Identical reference symbols indicate the same objects, so that where applicable, explanations from other figures can also be used. In the figures:

FIG. 1: shows a wheel drive according to the prior art in cross-section;

FIG. 2: shows a detail of a cross-section of a drive wheel having a groove in the cover;

FIG. 3: a detail of the cover from FIG. 2;

FIG. 4: shows the drive wheel in detail after formation of the interference fit but before rotation of the drive wheel; and

FIG. 5: shows a detail of the drive wheel from FIG. 4 after rotation of the drive wheel.

### DETAILED DESCRIPTION

FIG. 1 shows a drive wheel 1 according to the prior art as described above. A sufficient sealing action should be generated with a mere cylindrical interference fit. A cylindrical interference fit of two sheet metal parts (e.g., a drive disk 3 and a cover 34) should have two preferred regions “A” and “B” with high surface pressure and thus a certain sealing action due to the overlap in the assembled state as shown in FIG. 1. These form the first contact region A and the second contact region B between the cover 34 and the drive disk 3. The cover 34 is mounted in a radial direction on a support body 9, which is designed here as a press-fitted sliding bearing. Alternatively, the radial mounting of the cover 34 can also be achieved through the design of the cover 34 and the drive disk 3, for example by designing the cover 34 with a C-shaped cross-section and designing the drive disk 3 with an L-shaped cross-section.

The rotation of the drive wheel 1 takes place about a rotation axis 11. The drive disk 3 comprises a traction-means connection region 5 to which a traction means, not shown, such as a belt can be frictionally applied to transmit torque between the drive wheel 1 and the traction means. The drive wheel 1 also has a shaft connection region 8, via which the drive wheel 1 can be connected to a shaft, in particular a crankshaft of an internal combustion engine. In this way, torque can be transmitted in both directions between the internal combustion engine and an electrical assembly, such as an alternator or a starter generator, which is connected via the traction-means connection region 5 and a corresponding traction means.

Shaft connection region 8 and traction-means connection region 5 can be rotated relative to one another against a torsional vibration damping device 10. In this example, the torsional vibration damping device 10 comprises multiple springs 31, in particular bow springs, which are formed in a spring accommodation chamber 38 which is filled with a lubrication medium. In the example known from the prior art, the sealing essentially takes place via the first contact region A and the second contact region B. The first contact region A and the second contact region B are formed during press joining. It may be possible to specify the exact position of the first contact region A and/or the second contact region B through a rotary contour raised in this region during the manufacture of the interference fit.

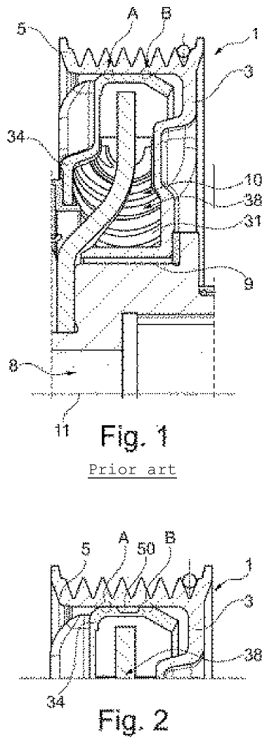

FIG. 2 shows a detail of a cross-section of a drive wheel 1 having a groove 50 in the cover 34. To avoid repetition, only the differences from the drive wheel 1 known from the prior art are explained here; otherwise, reference is made to the description of FIG. 1 above. In FIG. 2, a groove 50 is made in the inner component of the interference fit, i.e., in the cover 34, in the axial direction in relation to the axis of rotation 11 between the first contact region A and the second contact region B. The groove 50 can be produced later by mechanical processing or can be already introduced as an embossing during a stamping/forming process. The latter is preferred, since an additional process step in production can be avoided in this way. Depending on the required inner contour, this embossing can also be embossed into the spring chamber 38 on the inner diameter. The sealing means in the groove 50 is not shown in FIG. 2.

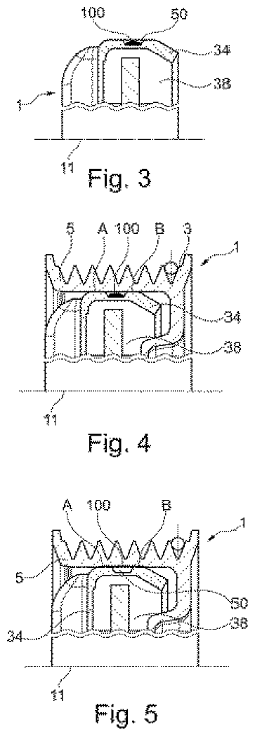

FIG. 3 shows a detail of the cover 34 from FIG. 2, wherein the groove 50 is designed with dimensions such that the required amount of sealing means 100 does not protrude via the cylindrical outer diameter of the cover 34 (internal component) after application (even under the action of gravity). In this way, the sealing means 100 can be prevented from escaping from the groove 50 when the cover 34 and the drive disk 3 are assembled.

FIG. 4 shows a detail of drive wheel 1 from FIG. 2 after formation of the interference fit between the drive disk 3 and the cover 34 in the contact regions A and B, but before rotation of the drive wheel 1 to displace the sealing means radially outward. FIG. 4 shows the assembly after the assembly process, wherein the amount of sealing means 100 applied is introduced into the interference fit during the assembly process, without some of it being wiped off at the front edge of the drive disk 3/the interference fit and without the component becoming unacceptably contaminated. After the assembly process, the sealing means 100 is located in the interference fit between the first contact region A and the second contact region B, which are arranged at the same location as in the prior art, i.e., axially on both sides of the groove 50 (see FIG. 1).

After the assembly process, the component is brought under the influence of speed. As a result, the sealing means 100 is conveyed outwards in the direction of centrifugal force and is placed in the interference fit to be sealed between the first contact region A and the second contact region B, and thus ensures the required sealing action. This is depicted in FIG. 5. The sealing means 100 is therefore within the groove 50 but radially on the inside of the drive disk 3. Furthermore, due to the rotation and the applied centrifugal force, the sealing means 100 penetrates into the increasingly narrowing gaps between the cover 34 and the drive disk 3 in the region of the first contact region A and the second contact region B. This can be further improved by using a correspondingly thixotropic sealing means 100.

By means of the described design of the drive wheel 1 and the assembly manufacturing method, the sealing means 100 is introduced into the appropriate region without the sealing means 100 getting outside of the interference fit. The sealing means 100 is then neither visible from the outside nor does it protrude into the spring accommodation chamber 38.

By introducing the groove 50 during the stamping/forming process, it is possible to carry out the interference fit without lathe machining of the cover 34/inner part, and to ensure the necessary tightness due to the additional sealing means 100.

### LIST OF REFERENCE SYMBOLS

1 Drive wheel
3 Drive disk
5 Traction-means connection region
8 Shaft connection region
9 Support body
10 Torsional vibration damping device
11 Axis of rotation
30 Spring device
31 Spring
34 Cover
38 Spring accommodation chamber
50 Groove
100 Sealing means
A First contact region
B Second contact region

1. A drive wheel comprising a drive disk, which has a traction-means connection region, and a shaft connection region, which can be rotated relative to the traction-means connection region against damping action of a torsional vibration damping device having a spring accommodation chamber, wherein the spring accommodation chamber is filled with lubrication medium and is closed via a cover, wherein the cover has a groove facing the drive disk and containing a sealing means.

2. The drive wheel according to claim 1, wherein the cover is press-fitted to the drive disk.

3. The drive wheel according to claim 1, wherein the cover is mounted on a support body in a radial direction.

4. The drive wheel according to claim 1, wherein the cover is produced from sheet metal solely via forming.

5. The drive wheel according to claim 4, wherein the cover remains unhardened after the forming.

6. The drive wheel according to claim 1, wherein the sealing means is positioned radially outwards in the groove.

7. The drive wheel according to claim 1, wherein an anaerobically hardened, thixotropic sealing means is used.

8. The drive wheel according to claim 1, wherein the drive disk and the cover form an interference fit with a first contact region and a second contact region, which are spaced apart from one another in an axial direction, wherein the groove is formed in the axial direction between the first contact region and the second contact region.

9. The drive wheel according to claim 8, wherein the sealing means rests radially on an inside between the first contact region and the second contact region on the drive disk and optionally on the cover.

10. A method for producing a drive wheel according to claim 1, comprising:
providing the drive disk with the torsional vibration damping device;
providing the cover;
introducing a sealing means into the groove;
press-fitting the cover into the drive disk; and
applying a rotational movement to the drive disk and the cover so that the sealing means is forced radially outwards out of the groove via centrifugal force and a joining point between the drive disk and cover is sealed in an axial region.

11. A drive wheel, comprising:
a drive disk having a traction-means connecting region and a shaft connecting region that is rotatable relative to the traction-means connecting region;
a torsional vibration damping device arranged radially between the traction-means connecting region and the shaft connecting region, the torsional vibration damping device including a cover having a radially outer surface:
contacting the drive disk at a first contacting region and at a second contacting region axially spaced from the first contacting region; and
having a groove arranged axially between the first contacting region and the second contacting region; and
sealing means arranged axially between the first contacting region and the second contacting region and radially between the cover and the drive disk.

12. The drive wheel of claim 11, wherein, prior to applying a rotational movement to the drive disk and the cover, the sealing means is arranged in the groove.

13. The drive wheel of claim 12, wherein, after applying a rotational movement to the drive disk and the cover, the sealing means is forced radially outward from the groove via centrifugal force.

14. The drive wheel of claim 13, wherein, after applying the rotational movement to the drive disk and the cover, the sealing means rests radially on an inside of the drive disk.

15. The drive wheel of claim 11, wherein the cover defines in part a spring accommodation chamber, the spring accommodation chamber being filled with a lubrication medium.

16. The drive wheel of claim 11, wherein the cover is press-fit into the drive disk.

17. The drive wheel of claim 11, wherein the cover is produced from sheet metal solely via forming.

18. The drive wheel of claim 17, wherein the cover remains unhardened after forming.

19. The drive wheel of claim 11, wherein an anaerobically hardened, thixotropic sealing means is used.

20. A drive wheel, comprising:
an outer component;
an inner component press-fit into the outer component, the inner component including a radially outer surface:
contacting the outer component at a first contacting region and at a second contacting region axially spaced from the first contacting region; and
having a groove arranged axially between the first contacting region and the second contacting region; and
sealing means arranged axially between the first contacting region and the second contacting region and radially between the outer component and the inner component.
